(19) United States
(12) Patent Application Publication
(10) Pub. No.: US 2026/0166931 A1
(43) Pub. Date: Jun. 18, 2026

(54) BALL-TYPE TRACTION ASSEMBLY

(71) Applicant: ANJI CHANGHONG CHAIN MANUFACTURING CO.,LTD, HUZHOU (CN)

(72) Inventors: Weibo YANG, HUZHOU (CN); Honghua WANG, HUZHOU (CN); Anyu YANG, HUZHOU (CN)

(73) Assignee: ANJI CHANGHONG CHAIN MANUFACTURING CO.,LTD, HUZHOU (CN)

(21) Appl. No.: 18/981,378

(22) Filed: Dec. 13, 2024

(51) Int. Cl. B60D 1/06

(52) U.S. Cl. CPC B60D 1/065

(57) ABSTRACT

The present invention discloses a ball-type traction assembly, comprising a ball socket allowing a traction ball to be installed in a position on a surface thereof; a hole is provided at a surface position of one side of the ball socket, wherein a position of the traction ball is limited through an installation mechanism, and by arranging a limiting mechanism, the traction ball may be guaranteed to be inserted into an interior of the ball socket to prevent the traction ball from rotating. The ball-type traction assembly is provided with the ball socket, the ball socket can be selectively arranged upward or downward, that is, a position of the traction ball relative to the ball socket can be reversed, such that a method of milling flat two side faces of a contact position between the traction ball and the ball socket can meet needs with no need of additional machining.

### TECHNICAL FIELD

The present invention relates to the technical field concerning ball type traction, in particular to a ball-type traction assembly.

### BACKGROUND

Existing car towing tools are a bolt and a trailer hitch arm. The bolt and the car towing arm are fixed to connect a front-drive car with a rear-traction transportation tool of towing dolly, trailer, etc., such that a ball-type traction assembly can be used for an auxiliary application, for example:
(1) a car towing ball disclosed by Publication No. CN201342914Y. The car towing ball comprises a screw rod part connected to a nut and a car towing ball body held on a connecting arm of a car. The car towing ball body is spherical and has a planar top part. A circular truncated cone base at a lower end of the car towing ball body has a simple and reasonable structure and will not become loose during use;

when the above device is in use, it is used through the arranged car towing ball. When the car towing ball is installed, it is necessary to use secondary limiting processing to prevent the car towing ball from loosening. Through the above device, additional fixing is required on the ball body, thus effectively preventing the loosening phenomenon of the ball body. This operation is not conducive to quick disassembly of the car towing rod;
(2) in addition, a car towing ball socket connection bushing device disclosed by Publication No. CN205890427U is combined. When this device is used, a bushing is placed between a car towing ball socket ball mounting hole and a car towing ball rod, and by adjusting a gap between the car towing ball socket and the car towing ball rod using a diameter-reducing seam, this device can adjust the gap between the car towing ball socket and the car towing ball rod for use;
however, there is a problem when this device is used. Since there will be a drawback while a traction assembly is installed when the car is used, it is needed to perform slotting on positions of two sides of the ball socket when installation is performed, to facilitate performing installation processing.

Therefore, we propose a ball-type traction assembly so as to solve the problems mentioned above.

### SUMMARY

The purpose of the present invention is to provide a ball-type traction assembly, to solve the problems raised by the above-mentioned background technology that traction assemblies currently on the market will loosen when in use, and may need slotting setting when in use.

In order to achieve the above purpose, the present invention provides the following technical solution: a ball-type traction assembly comprises a ball socket, a surface position of the ball socket is connected with a traction ball through an installation mechanism, the installation mechanism comprises a thread at a lower end of a traction ball and a hole provided on one side below the ball socket, a set of connecting seats are fixed at a position on one side of the ball socket away from the traction ball, moreover a locking hole is provided on one side of the connecting seat, and through providing the connecting seat and the locking hole, the ball-type traction assembly can be installed at an installation position on a car;
a hole is provided at a surface position of one side of the ball socket, a position of the traction ball is limited through an installation mechanism, and by arranging a limiting mechanism, the traction ball may be guaranteed to be inserted into an interior of the ball socket to prevent the traction ball from rotating; and
two side faces of a position where the traction ball is in contact with the ball socket are subjected to planarization treatment.

Preferably, the position where the traction ball is in contact with the ball socket is subjected to single-side planarization treatment, to provide a single-side flat surface; and a corresponding position of the hole in the ball socket is also subjected to planarization treatment, to provide a single-side flat surface.

Preferably, the position where the traction ball is in contact with the ball socket is subjected to two-side planarization treatment, to provide two-side flat surfaces; and the corresponding position of the hole in the ball socket is also subjected to planarization treatment, to provide two-side flat surfaces, and a top-view shape of the hole is set to a waist type.

Preferably, the installation and limiting mechanism comprises a thread provided at a lower end position of the traction ball, and after being inserted into the interior of the ball socket, the lower end position of the traction ball is fitted at a bottom position of the ball socket through a spring washer, and is additionally subjected to limiting fixation through a hexagonal nut, a user only needs to insert the towing ball into the interior of the ball socket, and then use a wrench to operate the hexagonal nut below, with no need for additional fixing of the ball body above. In addition, the installation and limiting mechanism comprises a flat surface of the ball socket and the traction ball.

Preferably, the ball socket can be selectively arranged upward, and the corresponding traction ball can also be selectively arranged upward. Two side faces that are milled flat are fixed in contact, are more stable, and are not prone to detachment from fixation.

Preferably, the ball socket can be arranged downward, the corresponding traction ball can also be arranged downward, and operation and use in different directions can be performed.

Preferably, a maximum diameter of a rod member below the traction ball is greater than a minimum diameter of the hole in the ball socket, and through the above-mentioned flat surface, rotation during assembly can be prevented, and friction force between threads during idling can be overcome.

Preferably, two-thirds of the rod member below the traction ball is inserted into the interior of the hole in the ball socket, such that the traction ball can be inserted into the inner part of the ball socket.

Compared with the prior art, the beneficial effects of the present invention are: the ball-type traction assembly is provided with a ball socket, the ball socket can be selectively arranged upward or downward, that is, a position of a traction ball relative to the ball socket can be reversed, such that a method of milling flat two side faces of a contact position between the traction ball and the ball socket can meet needs with no need of additional machining, can effectively prevent a loosening phenomenon during use, and is also suitable for quick disassembly and installation processing. The specific content is shown as follows:
1. a spring washer is provided, a hexagonal nut can be fastened on one side of the ball socket through the spring washer by using a wrench, and a loosening phenomenon between the ball socket and the traction ball can be avoided; and
2. two surfaces of an outer side of the ball socket both undergo milling machining, so that two side faces that are milled flat can be fixed in contact, are more stable and are not prone to detachment from fixation.

### BRIEF DESCRIPTION OF DRAWINGS

FIG. 1 is a schematic diagram of a three-dimensional structure of the present invention;

FIG. 2 is a three-dimensional explosive schematic diagram of the present invention;

FIG. 3 is a left-view structural schematic diagram of the present invention;

FIG. 4 is a bottom-view structural schematic diagram of the present invention;

FIG. 5 is a front-view structural schematic diagram of the present invention;

FIG. 6 is a left-view structural schematic diagram of the present invention;

FIG. 7 is a right-view structural schematic diagram of the present invention;

FIG. 8 is a top-view structural schematic diagram of the present invention;

FIG. 9 is a bottom-view schematic structural diagram of a ball socket in Embodiment 2 of the present invention;

FIG. 10 is a schematic front-view cross-sectional structural diagram of the ball socket in Embodiment 2 of the present invention; and

FIG. 11 is a structural schematic diagram of a single-side flat surface of the present invention.

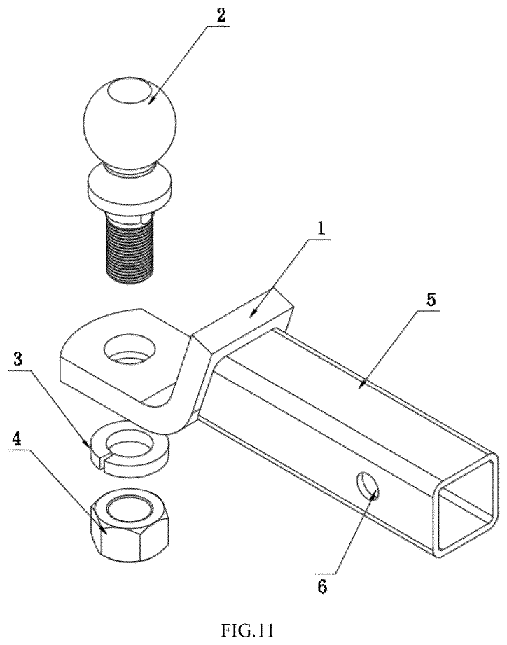

In the figures: 1. ball socket; 2. traction ball; 3. spring washer; 4. hexagonal nut; 5. connecting seat; 6. locking hole.

### DETAILED DESCRIPTION OF THE EMBODIMENTS

The technical solutions in embodiments of the present disclosure will be described clearly and completely below in conjunction with the accompanying drawings in the implementations of the present disclosure. Obviously, the described implementations are only a part of implementations of the present disclosure, but not all of them. On the basis of the implementations of the present disclosure, all other implementations obtained by those of ordinary skill in the art without involving any inventive effort should fall within the scope of protection of the present disclosure.

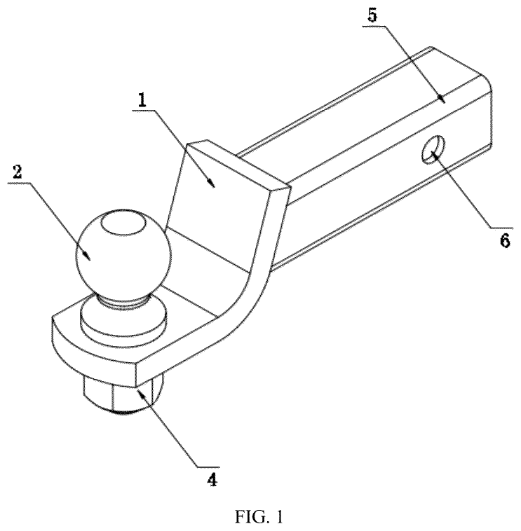

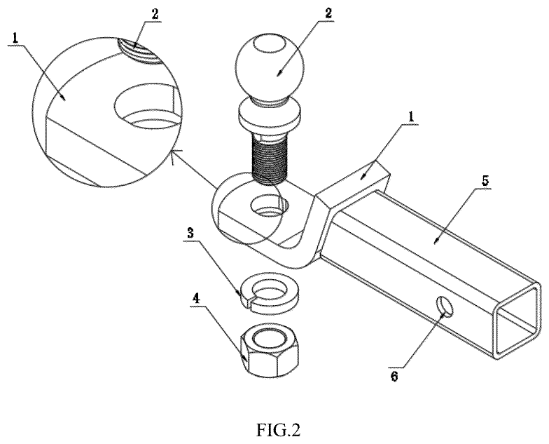

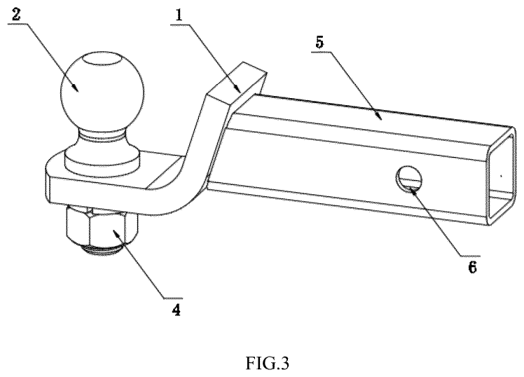

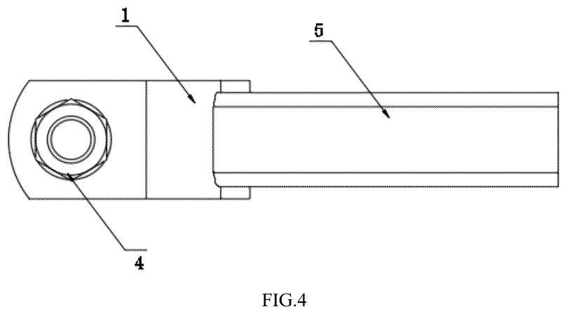

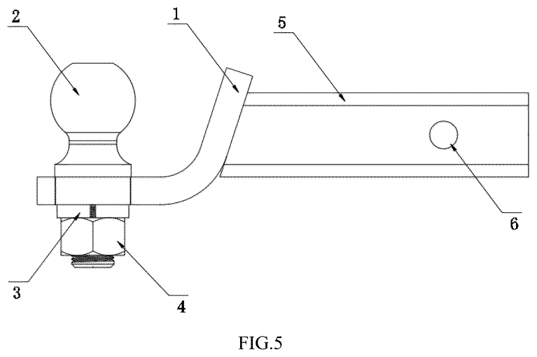

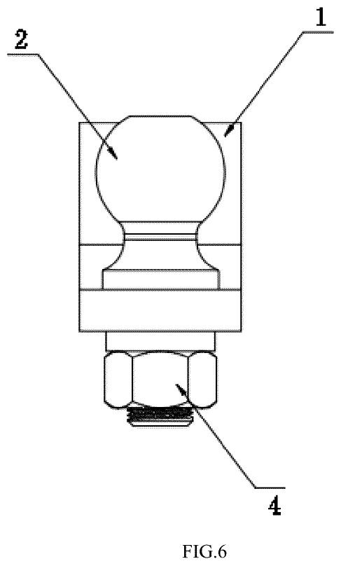

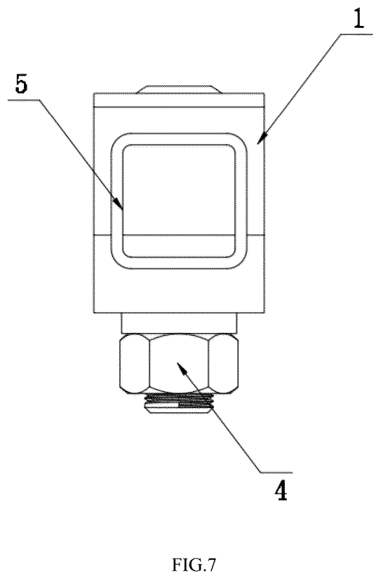

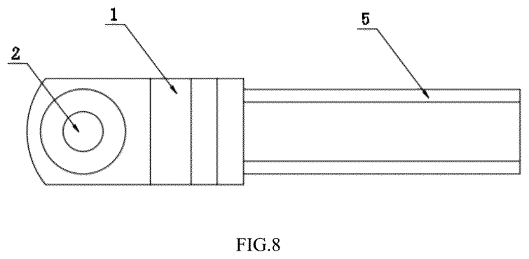

Referring to FIG. 1 to FIG. 8, the present invention provides the following technical solutions:
Embodiment 1: In order to solve the problem that a traction assembly on the market needs additional fixation of a ball body to effectively prevent the ball body from loosening, refer to FIG. 1 to FIG. 8. A ball socket 1 is included, a surface position of the ball socket 1 is connected with a traction ball 2 through an installation and limiting mechanism, the installation and limiting mechanism comprises a thread at a lower end of the traction ball 2 and a hole provided on one side below the ball socket 1, a hole is provided at a surface position of one side of the ball socket 1, a position of the traction ball 2 is limited by the installation and limiting mechanism, a set of connecting seats 5 are fixed at a position on one side of the ball socket 1 away from the traction ball 2, and a locking hole 6 is provided on one side of the connecting seat 5. By providing the connecting seat 5 and the locking hole 6, installing at an installation position on a car is allowed. By providing the installation and limiting mechanism, traction ball 2 may be guaranteed to be inserted into the interior of the ball socket 1 to prevent the traction ball 2 from rotating; a position where the traction ball 2 is in contact with the ball socket 1 is subjected to local planarization treatment, to provide a flat surface; a corresponding position of the hole in the ball socket 1 is also subjected to planarization treatment, and the position where the traction ball 2 is in contact with the ball socket 1 is subjected to two-side planarization treatment, to provide two-side flat surfaces; a corresponding position of the hole in the ball socket 1 is also subjected to planarization treatment, to provide two-side flat surfaces, a top-view shape of the hole is set to a waist type. the installation and limiting mechanism comprises a thread provided at a lower end position of the traction ball 2, and a lower end of the traction ball 2 is inserted into the interior of the ball socket 1, is then fitted to a bottom position of the ball socket 1 through a spring washer 3, and is additionally subjected to limiting and fixing treatment through a hexagonal nut 4; in addition, the installation and limiting mechanism comprises a flat surface of the ball socket 1 and the traction ball 2. In addition, the ball socket 1 can be selectively arranged upward, the corresponding traction ball 2 can also be selectively arranged upward. The ball socket 1 can be arranged downward, and the corresponding traction ball 2 can also be arranged downward. A maximum diameter of a rod member below the traction ball 2 is greater than a minimum diameter of the hole in the ball socket 1. Two-thirds of the rod member below the traction ball 2 is inserted into the interior of the hole in the ball socket 1. When this device is used, the lower end of the traction ball 2 is connected through the thread. When the existing traction assembly is installed, grooving treatment needs to be performed at positions on two sides. Therefore, by performing planarization treatment on positions of two side faces of the ball socket 1, when fixing is performed on the traction ball 2, fixing treatment is performed on the hexagonal nut 4 through a wrench, and it can be ensured that the two side faces that are milled flat are fixed in contact, are more stable, and are not prone to detachment from fixation.

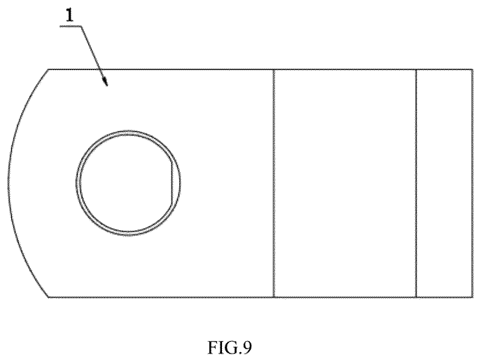

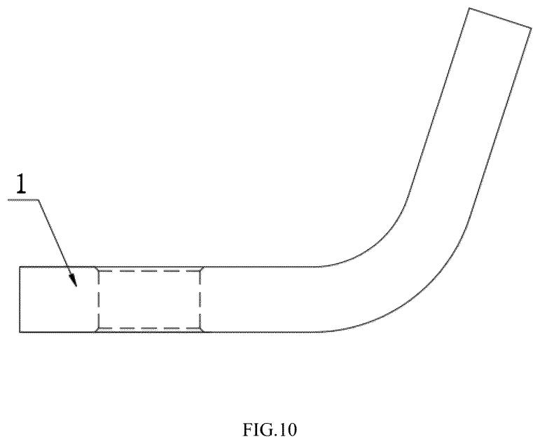

Embodiment 2: a difference between this embodiment and Embodiment 1 is that another one-side flat surface is disclosed. For details, refer to FIG. 9 and FIG. 10; in this embodiment, a contact surface of the ball socket 1 and a contact surface of the traction ball 2 fit together, and a position where the traction ball 2 is in contact with the ball socket 1 is subjected to single-side planarization treatment, to provide a single-side flat surface; the corresponding position of the hole in the ball socket 1 is also subjected to planarization treatment, to provide a single-side flat surface. A position where the traction ball 2 is in contact with the ball socket 1 is subjected to single-side planarization treatment, wherein a machining method of the planarization treatment is any one of milling, planing, cutting, stamping, etc. The corresponding position of the hole in the ball socket 1 is also subjected to planarization treatment. A single side face of the traction ball 2 is subjected to planarization treatment. One side face of the traction ball 2 is subjected to planarization treatment. A maximum diameter of the traction ball 2 is 25.9 mm (±0.05 mm). A circle provided in a middle part is a large diameter 1″ (25.02-25.28) of the thread, and the innermost ¾ circle is a bottom diameter of the thread.

Although the present invention has been described in detail with reference to the foregoing embodiments, those skilled in the art can still modify the technical solutions recorded in the foregoing embodiments, or make equivalent substitutions for some of the technical features. Any modifications, equivalent substitutions, improvements, etc. made within the spirit and principles of the present invention shall be included in the protection scope of the present invention.

What is claimed is:

1. A ball-type traction assembly, comprising a ball socket (1), wherein a surface position of the ball socket (1) is connected with a traction ball (2) through an installation and limiting mechanism, the installation and limiting mechanism comprises a thread at a lower end of the traction ball (2) and a hole provided on one side below the ball socket (1), a set of connecting seats (5) are fixed at a position on one side of the ball socket (1) away from the traction ball (2), and a locking hole (6) is provided on one side of the connecting seat (5), and by providing the connecting seat (5) and the locking hole (6), the ball-type traction assembly can be installed at an installation position on a car;
further comprising:
a hole being provided at a surface position of one side of the ball socket (1), wherein a position of the traction ball (2) is limited through an installation and limiting mechanism, and by arranging the installation and limiting mechanism, the traction ball (2) may be guaranteed to be inserted into an interior of the ball socket (1) to prevent the traction ball (2) from rotating;
a position where the traction ball (2) is in contact with the ball socket (1) being subjected to local planarization treatment, to provide a flat surface;
a corresponding position of the hole in the ball socket (1) being also subjected to planarization treatment; and a contact surface of the ball socket (1) and a contact surface of the traction ball (2) fitting together.

2. The ball-type traction assembly according to claim 1, wherein, the position where the traction ball (2) is in contact with the ball socket (1) is subjected to single-side planarization treatment, to provide a single-side flat surface; and the corresponding position of the hole in the ball socket (1) is also subjected to planarization treatment, to provide a single-side flat surface.

3. The ball-type traction assembly according to claim 1, wherein, the position where the traction ball (2) is in contact with the ball socket (1) is subjected to two-side planarization treatment, to provide two-side flat surfaces; and the corresponding position of the hole in the ball socket (1) is also subjected to planarization treatment, to provide two-side flat surfaces, and a top-view shape of the hole is set to a waist type.

4. The ball-type traction assembly according to claim 1, wherein, the installation and limiting mechanism comprises a thread provided at a lower end position of the traction ball (2), after being inserted into the interior of the ball socket (1), the lower end position of the traction ball (2) is fitted at a bottom position of the ball socket (1) through a spring washer (3) and is additionally subjected to limiting and fixing treatment through a hexagonal nut (4), and in addition, the installation and limiting mechanism comprises a flat surface of the ball socket (1) and the traction ball (2).

5. The ball-type traction assembly according to claim 4, wherein, the ball socket (1) can be selectively arranged upward, and the corresponding traction ball (2) can also be selectively arranged upward.

6. The ball-type traction assembly according to claim 4, wherein, the ball socket (1) can be arranged downward, and the corresponding traction ball (2) can also be arranged downward.

7. The ball-type traction assembly according to claim 4, wherein, a maximum diameter of a rod member below the traction ball (2) is greater than a minimum diameter of the hole in the ball socket (1).

8. The ball-type traction assembly according to claim 4, wherein, the distance by which the rod member below the traction ball (2) is inserted into the interior of the hole in the ball socket (1) is two-thirds of the rod member.

9. The ball-type traction assembly according to claim 2, wherein, the installation and limiting mechanism comprises a thread provided at a lower end position of the traction ball (2), after being inserted into the interior of the ball socket (1), the lower end position of the traction ball (2) is fitted at a bottom position of the ball socket (1) through a spring washer (3) and is additionally subjected to limiting and fixing treatment through a hexagonal nut (4), and in addition, the installation and limiting mechanism comprises a flat surface of the ball socket (1) and the traction ball (2).

10. The ball-type traction assembly according to claim 3, wherein, the installation and limiting mechanism comprises a thread provided at a lower end position of the traction ball (2), after being inserted into the interior of the ball socket (1), the lower end position of the traction ball (2) is fitted at a bottom position of the ball socket (1) through a spring washer (3) and is additionally subjected to limiting and fixing treatment through a hexagonal nut (4), and in addition, the installation and limiting mechanism comprises a flat surface of the ball socket (1) and the traction ball (2).
